(19) United States
(12) Patent Application Publication
(10) Pub. No.: US 2014/0189243 A1
(43) Pub. Date: Jul. 3, 2014

(54) SECTORED CACHE WITH HYBRID LINE GRANULARITY

(71) Applicants: Blas CUESTA, Barcelona (ES); Qiong CAI, Barcelona (ES); Nevin HYUSEINOVA, Barcelona (ES); Serkan OZDEMIR, Barcelona (ES); Marios NICOLAIDES, Barcelona (ES); Ferad ZYULKYAROV, Barcelona (ES)

(72) Inventors: Blas CUESTA, Barcelona (ES); Qiong CAI, Barcelona (ES); Nevin HYUSEINOVA, Barcelona (ES); Serkan OZDEMIR, Barcelona (ES); Marios NICOLAIDES, Barcelona (ES); Ferad ZYULKYAROV, Barcelona (ES)

(21) Appl. No.: 13/729,523

(22) Filed: Dec. 28, 2012

(51) Int. Cl. G06F 12/08

(52) U.S. Cl. CPC G06F 12/0864
USPC 711/128

(57) ABSTRACT

A coarse-grained cache line may be associated with a way from a set in a cache. A first sector of the coarse-grained cache line may be stored in the way. The coarse-grained cache line may include a predetermined number of sectors. A fine-grained cache line may be associated with the way. A second sector of the fine-grained cache line may be stored in the way. The fine-grained cache line may include a predetermined number of sectors. The predetermined number of sectors in the fine-grained cache line may be lower than the predetermined number of sectors in the coarse-grained cache line.

### FIELD OF THE INVENTION

The present disclosure pertains to the field of caches.

### BACKGROUND

Advances in memory technologies have led to the development of extremely large system caches. The sizes of these large caches may be in the order of hundreds of megabytes on the client side and several gigabytes on the server side. The organization of the tag array for such large caches is a key aspect of their design because it has a significant impact on both area required for the tag array and latency. Conventional cache organizations, however, are inefficient due to the large area required for the tag array.

### DESCRIPTION OF THE FIGURES

Embodiments are illustrated by way of example and not limitation in the Figures of the accompanying drawings:

FIG. 1 illustrates a processor including multiple processing elements according to an embodiment.

FIG. 2 illustrates on-core memory interface logic according to an embodiment.

FIG. 3 illustrates a sectored cache according to an embodiment.

FIG. 4 illustrates a hybrid grained sectored cache according to an embodiment.

FIG. 5 illustrates data structures to facilitate the access of data in hybrid grained sectored caches.

FIG. 6 is a flow diagram illustrating a method to insert a sector into a hybrid grained sectored cache according to an embodiment.

FIG. 7 is a block diagram of an exemplary computer system according to an embodiment.

### DETAILED DESCRIPTION

In the following description, numerous specific details are set forth such as examples of specific hardware structures for storing/caching data, as well as placement of such hardware structures; specific processor units/logic, specific examples of processing elements, etc., in order to provide a thorough understanding of the present invention. It will be apparent, however, to one skilled in the art that these specific details need not be employed to practice the present invention. In other instances, well known components or methods, such as specific counter circuits, alternative multi-core and multi-threaded processor architectures, specific uncore logic, specific memory controller logic, and specific operational details of microprocessors, have not been described in detail in order to avoid unnecessarily obscuring the present invention.

Embodiments may be discussed herein pertaining to efficient caching. In an embodiment a coarse-grained cache line may be associated with a way from a set in a cache. A first sector of the coarse-grained cache line may be stored in the way. The coarse-grained cache line may include a predetermined number of sectors. A fine-grained cache line may be associated with the way. A second sector of the fine-grained cache line may be stored in the way. The fine-grained cache line may include a predetermined number of sectors. The predetermined number of sectors in the fine-grained cache line may be lower than the predetermined number of sectors in the coarse-grained cache line.

In an embodiment, the predetermined number of sectors in the fine-grained line may be one sector. In an embodiment, associating the coarse-grained cache line may include storing a line tag of the coarse-grained cache line in a tag array associated with the cache. Storing the first sector may include setting an indicator in the tag array to indicate the first sector is valid. In an embodiment, associating the fine-grained cache line may include storing, in a data structure, an indicator indicating the way and an indicator indicating a location in the way reserved to store the fine-grained line.

In an embodiment, if a sector to be inserted in a cache belongs to a coarse-grained cache line associated with a way in the cache, the sector may be stored in the way associated with the coarse-grained cache line. If the sector does not belong to any coarse-grained cache line associated with a way in the cache and if the sector belongs to a fine-grained cache line associated with a way in the cache, the sector may be stored in the way associated with the fine-grained cache line. In an embodiment, if the sector does not belong to any coarse-grained cache line associated with a way in the cache and if the sector does not belong to any fine-grained cache line associated with a way in the cache, the system may search for an empty way in a set corresponding to the sector. If the empty way is identified, a coarse-grained cache line including the sector may be associated with the empty way. The sector may be stored in the empty way. In an embodiment, if no empty ways are available, the processor may search for a way with free space to store a fine-grained cache line including the sector. If the way with free space is identified, the processor may search for free space to insert an entry in a data structure. The data structure may include associations between fine-grained cache lines and ways in the cache. If the free space to insert the entry is available, the fine-grained cache line may be associated with the way with free space in the data structure. The sector may be stored in the way with free space. In an embodiment, if ways with free space are not available or if free space to insert the entry is not available, a victim way may be identified. A fine-grained line or a coarse-grained line may be replaced in the victim way. The sector may be stored in the victim way. In an embodiment, the victim way may be identified through a least recently used policy and/or a most recently used policy.

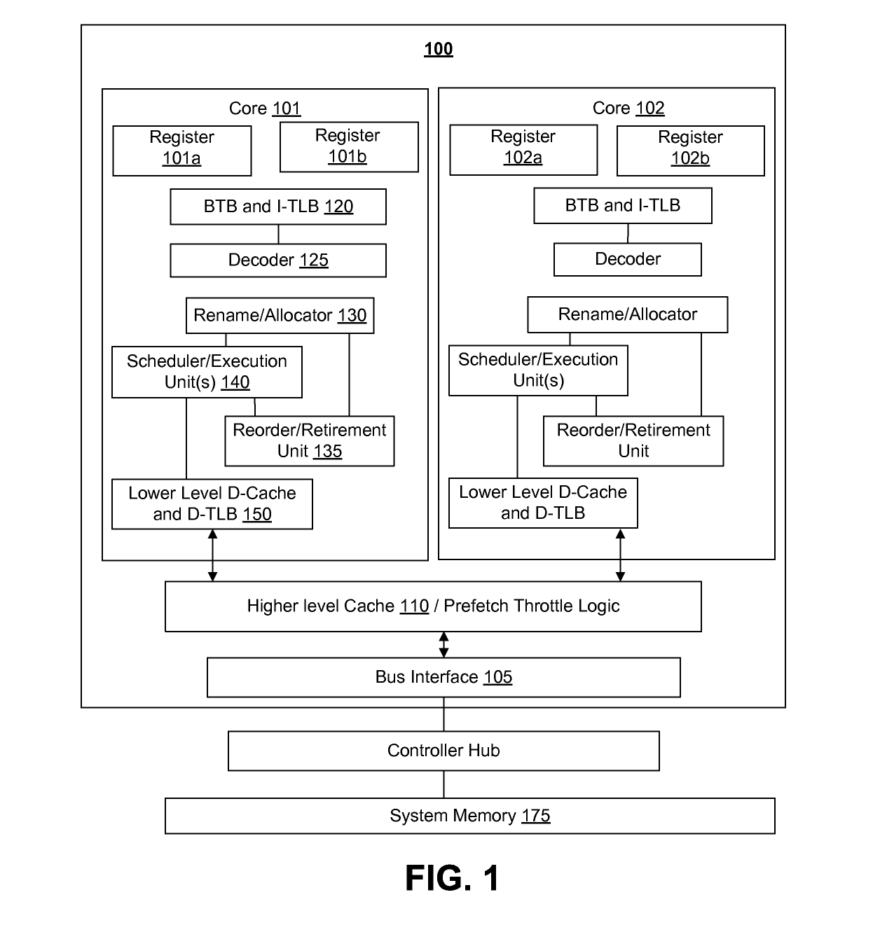

Referring to FIG. 1, an embodiment of a processor including multiple cores is illustrated. Processor 100, in one embodiment, includes one or more caches. Processor 100 includes any processor, such as a micro-processor, an embedded processor, a digital signal processor (DSP), a network processor, or other device to execute code. Processor 100, as illustrated, includes a plurality of processing elements.

In one embodiment, a processing element refers to a thread unit, a thread slot, a process unit, a context, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state wherein each independently maintained architectural state is associated with at least some dedicated execution resources. In contrast to cores, a hardware thread typically refers to any logic located on an integrated circuit capable of maintaining an independent architectural state wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores, core 101 and 102. Here, core hopping may be utilized to alleviate thermal conditions on one part of a processor. However, hopping from core 101 to 102 may potentially create the same thermal conditions on core 102 that existed on core 101, while incurring the cost of a core hop. Therefore, in one embodiment, processor 100 includes any number of cores that may utilize core hopping. Furthermore, power management hardware included in processor 100 may be capable of placing individual units and/or cores into low power states to save power. Here, in one embodiment, processor 100 provides hardware to assist in low power state selection for these individual units and/or cores.

Although processor 100 may include asymmetric cores, i.e. cores with different configurations, functional units, and/or logic, symmetric cores are illustrated. As a result, core 102, which is illustrated as identical to core 101, will not be discussed in detail to avoid repetitive discussion. In addition, core 101 includes two hardware threads 101a and 101b, while core 102 includes two hardware threads 102a and 102b. Therefore, software entities, such as an operating system, potentially view processor 100 as four separate processors, i.e. four logical processors or processing elements capable of executing four software threads concurrently.

Here, a first thread is associated with architecture state registers 101a, a second thread is associated with architecture state registers 101b, a third thread is associated with architecture state registers 102a, and a fourth thread is associated with architecture state registers 102b. As illustrated, architecture state registers 101a are replicated in architecture state registers 101b, so individual architecture states/contexts are capable of being stored for logical processor 101a and logical processor 101b. Other smaller resources, such as instruction pointers and renaming logic in rename allocater logic 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register, low level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, processor 100 includes a branch target buffer 120 to predict branches to be executed/taken and an instruction-translation buffer (I-TLB) 120 to store address translation entries for instructions.

Processor 100 further includes decode module 125 is coupled to fetch unit 120 to decode fetched elements. In one embodiment, processor 100 is associated with an Instruction Set Architecture (ISA), which defines/specifies instructions executable on processor 100. Here, often machine code instructions recognized by the ISA include a portion of the instruction referred to as an opcode, which references/specifies an instruction or operation to be performed.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

As depicted, cores 101 and 102 share access to higher-level or further-out cache 110, which is to cache recently fetched elements. Note that higher-level or further-out refers to cache levels increasing or getting further way from the execution unit(s). In one embodiment, higher-level cache 110 is a last-level data cache—last cache in the memory hierarchy on processor 100—such as a second or third level data cache. However, higher level cache 110 is not so limited, as it may be associated with or include an instruction cache. A trace cache—a type of instruction cache—instead may be coupled after decoder 125 to store recently decoded traces.

Note, in the depicted configuration that processor 100 also includes bus interface module 105 to communicate with devices external to processor 100, such as system memory 175, a chipset, a northbridge, or other integrated circuit. Memory 175 may be dedicated to processor 100 or shared with other devices in a system. Common examples of types of memory 175 include dynamic random access memory (DRAM), static RAM (SRAM), non-volatile memory (NV memory), and other known storage devices.

Note that in the depicted embodiment, the controller hub and memory are illustrated outside of processor 100. However, the implementations of the methods and apparatus' described herein are not so limited. In fact, as more logic and devices are being integrated on a single die, such as System on a Chip (SOC), each of these devices may be incorporated on processor 100. For example in one embodiment, memory controller hub is on the same package and/or die with processor 100. Here, a portion of the core (an on-core portion) includes a controller hub for interfacing with other devices such as a controller hub. In the SOC environment, even more devices, such as the network interface, co-processors, and any other known computer devices/interface may be integrated on a single die or integrated circuit to provide small form factor with high functionality and low power consumption.

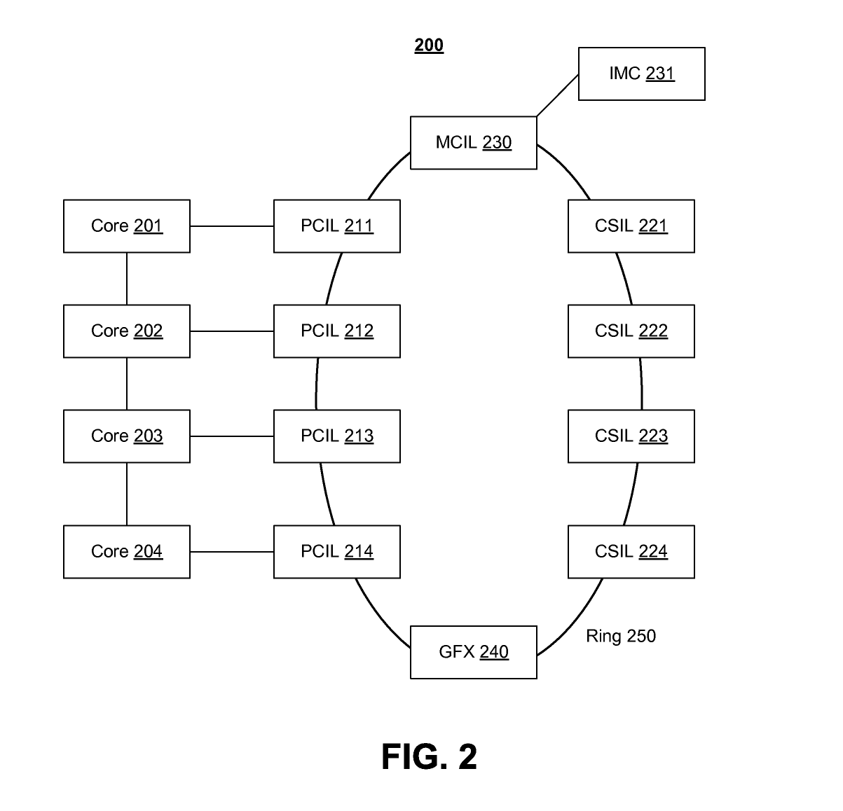

FIG. 1 illustrates an abstracted, logical view of an exemplary processor with a representation of different modules, units, and/or logic. However, note that a processor utilizing the methods and apparatus' described herein need not include the illustrated units. And, the processor may omit some or all of the units shown. To illustrate the potential for a different configuration, the discussion now turns to FIG. 2, which depicts an embodiment of processor 200 including an on-processor memory interface module—an uncore module—with a ring configuration to interconnect multiple cores. Processor 200 is illustrated including a physically distributed cache; a ring interconnect; as well as core, cache, and memory controller components. However, this depiction is purely illustrative, as a processor implementing the described methods and apparatus may include any processing elements, style or level of cache, and/or memory, front-side-bus or other interface to communicate with external devices.

In one embodiment, caching agents 221-224 are each to manage a slice of a physically distributed cache. As an example, each cache component, such as component 221, is to manage a slice of a cache for a co-located core—a core the cache agent is associated with for purpose of managing the distributed slice of the cache. As depicted, cache agents 221-224 are referred to as Cache Slice Interface Logic (CSIL)s; they may also be referred to as cache components, agents, or other known logic, units, or modules for interfacing with a cache or slice thereof. Note that the cache may be any level of cache; yet, for this exemplary embodiment, discussion focuses on a last-level cache (LLC) shared by cores 201-204.

Much like cache agents handle traffic on ring interconnect 250 and interface with cache slices, core agents/components 211-214 are to handle traffic and interface with cores 201-204, respectively. As depicted, core agents 221-224 are referred to as Processor Core Interface Logic (PCIL)s; they may also be referred to as core components, agents, or other known logic, units, or modules for interfacing with a processing element Additionally, ring 250 is shown as including Memory Controller Interface Logic (MCIL) 230 and Graphics Hub (GFX) 240 to interface with other modules, such as memory controller (IMC) 231 and a graphics processor (not illustrated). However, ring 250 may include or omit any of the aforementioned modules, as well as include other known processor modules that are not illustrated. Additionally, similar modules may be connected through other known interconnects, such as a point-to-point interconnect or a multi-drop interconnect.

It's important to note that the methods and apparatus' described herein may be implemented in any cache at any cache level, or at any processor or processor level. Furthermore, caches may be organized in any fashion, such as being a physically or logically, centralized or distributed cache.

Advances in memory technologies have led to the development of extremely large system caches. The sizes of these large caches may be in the order of hundreds of megabytes on the client side and several gigabytes on the server side. The organization of the tag array for such large caches is a key aspect of their design because it has a significant impact on both area required for the tag array and latency. Conventional cache organizations are inefficient due to the large area required for the tag array. For example, a 512 MB cache organized in 64-byte blocks would require a 16 MB tag array.

To alleviate this limitation, sectored caches may be utilized. According to this organization, cached data is grouped into lines and sectors so that a large amount of data is associated with a relatively small number of tag bits. Consequently, the physical area requirements of the tag arrays required by sectored caches are significantly smaller than those of the conventional organizations such as the 64-byte block organization. For example, a 512 MB sectored cache only requires a 512 KB tag array.

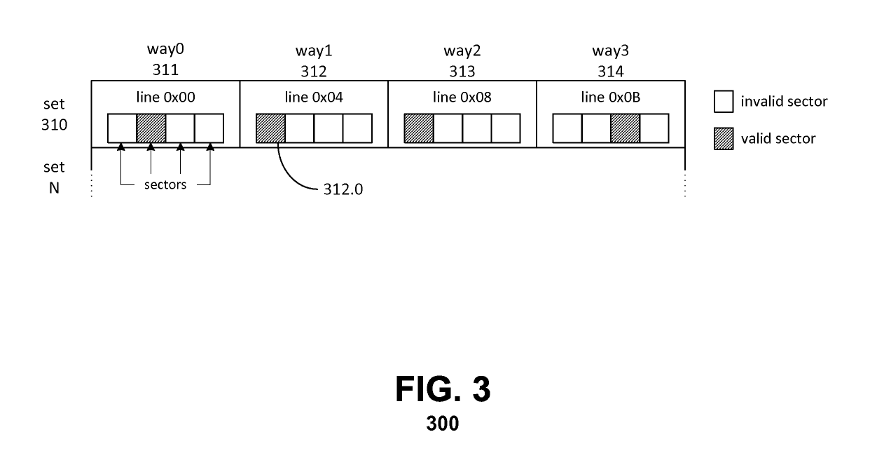

FIG. 3 illustrates a sectored cache 300 according to an embodiment. The cache 300 may be a set-associative cache. For example, the cache 300 is shown in FIG. 3 as a 4-way set-associative cache. Thus, each set in cache 300 may include four ways (or cache lines). Namely, set 310 may include four ways: way 311, way 312, way 313, and way 314. Each way may include a cache line having sectors. For example, each way 311-314 may include a cache line with four sectors.

Each sector of a cache line may include a “valid” bit indicating whether the sector includes valid data. When there is a cache miss, instead of fetching an entire cache line and loading it into the cache, only the necessary sector may be loaded. For example, if there is a cache miss to sector 312.0, instead of fetching line 0x04 from main memory (as in a conventional non-sectored cache), only the data corresponding to sector 312.0 may be fetched. Prior to fetching sector 312.0, if no data from line 0x04 was present in cache 300, the address of line 0x04 may be set.

In a conventional non-sectored cache, the only way to achieve a large capacity with a relatively small number of tag bits is to make the cache lines very large. A problem with this approach is that each cache miss will result in the retrieval of a large amount of data, and thus negatively impact performance. But in a sectored cache, since it is possible to fetch a single sector of a cache line, the time to process a cache miss and the bus traffic can both be decreased.

A disadvantage of a sectored cache, however, is that the space available in the cache is usually not efficiently utilized. For example, it is possible that each of the cache lines in set 310: 0x00, 0x04, 0x08, and 0x0B may have a single valid sector and three invalid sectors. In such a case, only 25% of the available space in set 310 is utilized. However, a subsequent insertion of a sector from a new cache line (for example, line 0x10) into set 310 will result in the removal of one of the existing cache lines in set 310 since set 310 has cache lines in all four ways. Thus, one of the cache lines which only had 25% of valid data will be removed, resulting in inefficient usage of cache space.

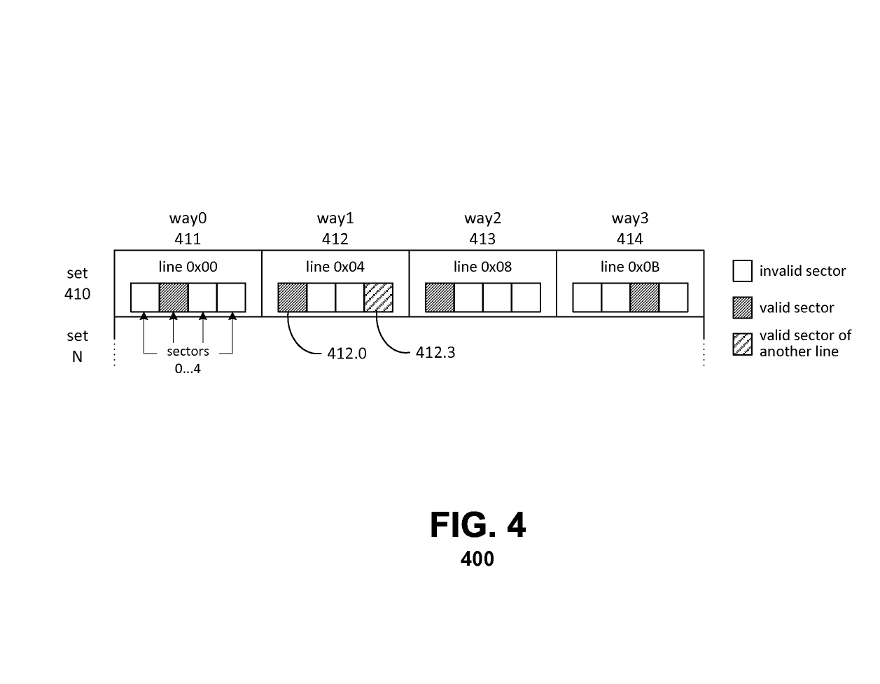

The above problems may be addressed by hybrid grained sectored caches. FIG. 4 illustrates a hybrid grained sectored cache 400 according to an embodiment. The cache 400 may be a set-associative cache. For example, the cache 400 is shown in FIG. 4 as a 4-way set-associative cache. Therefore, set 410 may include four ways: way 411, way 412, way 413, and way 414. Each way may include a cache line having sectors. For example, each way 411-414 may include a cache line with four sectors. Each sector of a cache line may include a “valid” bit indicating whether the sector includes valid data.

In an embodiment, when there is a cache miss, the necessary sector(s) may be loaded into the cache in either a coarse-grained mode or a fine-grained mode depending on the available space in the cache. For example, if there is a cache miss to the data corresponding to sector 412.0, the system (or a component of the system such as a cache controller) may first check whether there is enough space to insert a coarse-grained line (line 0x04) which includes sector 412.0. That is, the system may check for empty ways in cache 400. If there is an empty way, for example, way 412, the system may set the address tag of the line within way 412 to the address corresponding to line 0x04. The system may then fetch/load the necessary data into sector 412.0. If the system determines that there is not enough space to insert a coarse-grained line, it may then attempt to insert a fine-grained line. For example, if there is subsequently a cache miss to data from a particular sector in a cache line, for example, line 0x10, the system may determine whether there are any empty ways to insert line 0x10 in a coarse-grained mode as discussed above. However, the system may determine that every way in cache 400 is already filled with coarse-grained lines. Therefore, the system may attempt to insert the sector from line 0x10 in a fine-grained mode. In the fine-grained mode, the system may insert a portion of a first cache line (i.e., a fine-grained line) into available space reserved for a second cache line (i.e., a coarse-grained line) in cache 400. The second cache line may not be evicted in order to insert the portion of the first cache line. Continuing with the discussed example, the system may determine that way 412, which is reserved for line 0x04 has one valid sector, but three available sectors. Therefore the system may insert the data corresponding to the sector in line 0x10 into sector 412.3. Since additional sectors not belonging to coarse-grained lines in a set may be cached without causing the eviction of the coarse-grained lines, more of the sectors belonging to the coarse-grained lines may be filled, resulting in a better cache hit ratio.

The examples discussed above are explained in a context where a fine-grained line is the size of a single sector. However, a person having ordinary skill in the art will appreciate that the pre-determined size of a fine-grained line may be any size as long as it is smaller than the size of a coarse-grained line (i.e., smaller than the size of a cache line).

Although each cache line in FIG. 3 and FIG. 4 are illustrated as having four sectors, a person having ordinary skill in the art will appreciate that in other embodiments, each cache line may include any predetermined number of sectors.

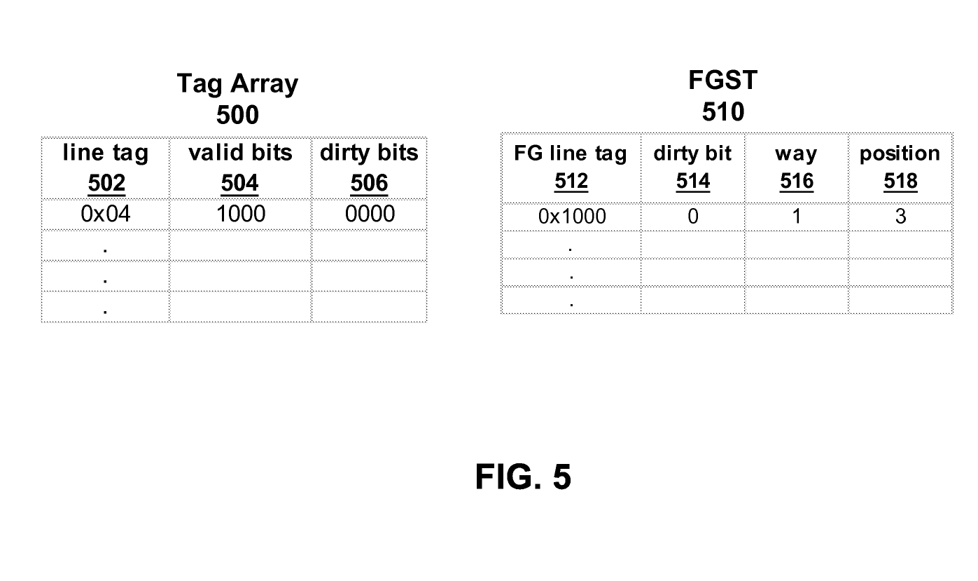

FIG. 5 illustrates data structures to facilitate the access of data in hybrid grained sectored caches. In an embodiment, two data structures may keep track of the data in a hybrid grained sector cache such as cache 400: a tag array 500 and a fine-grained sectoring table (FGST) 510. The tag array 500 may include information associated with coarse-grained lines. Specifically, the tag array 500 may include the addresses of cache lines (coarse-grained lines) stored in the corresponding hybrid grained sector cache (line tags 502), indicators indicating the sectors in a coarse-grained line which include valid data (valid bits 504), and/or indicators indicating the sectors in a coarse-grained line which include written or dirty data (dirty bits 506). Dirty data is data written to the cache but not yet written to memory. Tag array 500 illustrates exemplary information associated with the coarse-grained line 0x04 shown in FIG. 4. As seen, the line tag 502 indicates 0x04 as the tag of the coarse-grained line. The valid bits 504 indicate 1000 since the only valid sector from line 0x04 is the first sector 412.0 (thus, only the first bit from the valid bits 504 is set to 1). Note that the last bit from the valid bits 504 is not set even though sector 412.3 contains valid data because sector 412.3 does not belong to line 0x04, but to another line. The dirty bits 506 indicate that no dirty writes were performed on sector 412.0 since the bits are set to 0000. Responsive to a dirty write to sector 412.0, the dirty bits 502 may be set to 1000.

The FGST 510 includes information associated with fine-grained lines. The FGST 510 may include a fine-grained line tag 512 to identify each fine-grained line, a dirty bit (or dirty bits) 514 to indicate whether the fine-grained line includes written or dirty data, a way indicator 516 to indicate the cache way in which the fine-grained line is located, and a position indicator 518 to indicate the first sector of the fine-grained line in the corresponding way 516.

FIG. 5 is discussed in a context where a fine-grained line is the size of a single sector. However, a person having ordinary skill in the art will appreciate that the pre-determined size of a fine-grained line may be any size as long as it is smaller than the size of a coarse-grained line (i.e., smaller than the size of a cache line). In an embodiment, if a fine-grained line included multiple sectors, additional dirty bits 516 may be included in the FGST 510 to keep track of each dirtied sector in the fine-grained line. In a further embodiment, if a fine-grained line included multiple sectors, the FGST 510 may include indicators indicating the sectors in the fine-grained line which include valid data (analogous to valid bits 504).

FGST 510 illustrates exemplary information associated with the sector 412.3 shown in FIG. 4. As seen, the fine-grained line tag 512, 0x1000, is the identifier of the fine-grained line (which in FIG.4 is a single sector 412.3). The way indicator 516 indicates that the fine-grained line 412.3 is located in the way 1 (412) of the set. The position indicator 518 indicates that the first (and only) sector of the fine-grained line 412.3 is located in position 3 (note that position 0 indicates the first sector and therefore, position 3 indicates the fourth sector) of way 412.

Since two data structures are used for keeping track of cached sectors, the system (or a component of the system such as a cache controller) may perform a lookup in both to check whether a sector is cached. In an embodiment, both lookups may be performed in parallel to reduce the lookup latency. Responsive to a read/write request, the system may simultaneously look up the requested sector in the FGST 510 (using the tag of the fine-grained line 512 which the requested sector belongs to) and in the tag array 500 (using the tag of the coarse-grained line 502 which the requested sector belongs to). Based on the lookup, the system may determine that: 1) the line is found in the tag array 500 and the valid bit 504 for the requested sector is set which means that the requested sector is in the cache (a sector hit), 2) the line is found in the tag array 500 and the valid bit 504 for the sector is unset which means that the requested sector is not in the cache (coarse-grained line hit but sector miss), 3) the line is not found in the tag array 500, but the line is found in the FGST 510 and the valid bit 504 for the requested sector is set (sector hit since the requested sector is in the cache), 4) the line is not found in the tag array 500, but the line is found in the FGST 510 and the valid bit 504 for the requested sector is unset (fine-grained line hit but sector miss), or 5) the line is not found in the tag array 500 or the FGST 510 (line and sector miss).

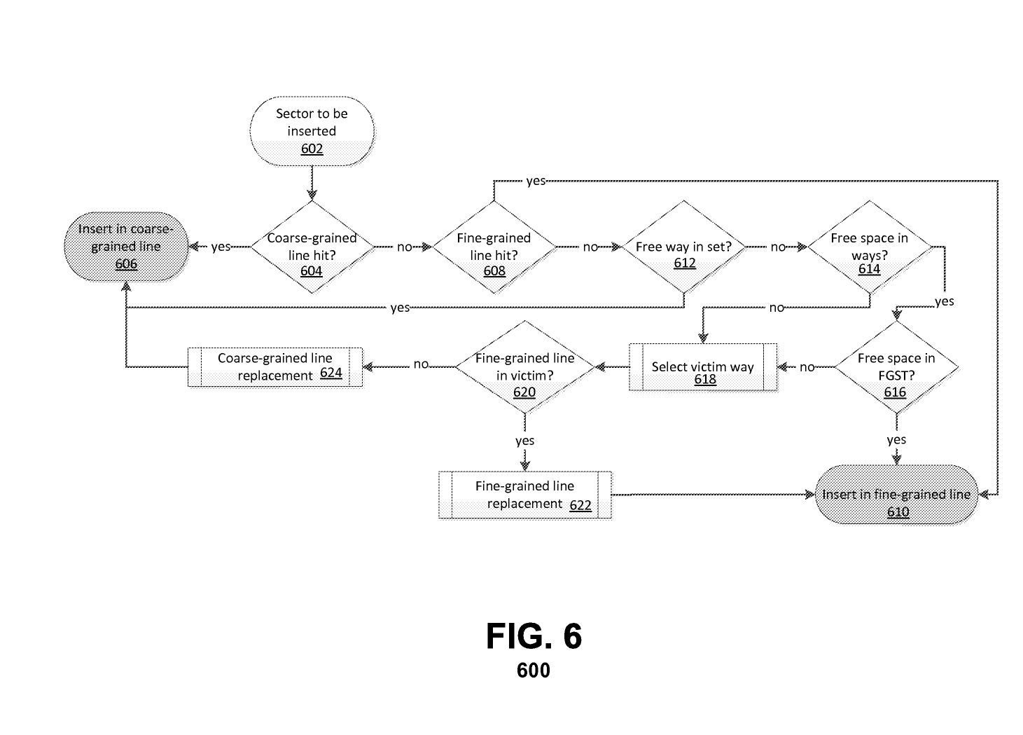

FIG. 6 is a flow diagram illustrating a method 600 to insert a sector into a hybrid grained sectored cache according to an embodiment. If the sector to be inserted in the cache 602 belongs to a line that exists in the tag array 604 (i.e., it is a sector miss but a coarse-grained line hit), the method 600 may insert the sector in the coarse-grained line 606 and the tag array may keep track of it. In an embodiment, if the target sector location is already occupied by a fine-grained line, higher priority may be given to the coarse granularity, and therefore, the fine-grained line may be invalidated and replaced. This policy of favoring coarse-grained lines over fine-grained lines may be advantageous because the tracking of sectors belonging to coarse-grained lines may require less information. If the sector to be inserted in the cache 602 does not belong to any line in the tag array 604 the method 600 checks whether it belongs to any of the lines in the FGST 608. If so, the sector may be inserted in the fine-grained line 610 and the FGST keeps track of it. Otherwise, the method 600 searches for an empty way 612 in the corresponding set. If at least one of the ways in the set is empty, the coarse-grained line including the sector is associated with the empty way and the sector is inserted in the coarse-grained line 606. Doing so enforces a policy of first filling all the ways with coarse-grained lines and then filling the lines with sectors.

If there are no free ways 612 in the corresponding set, the method 600 may determine whether there is enough space in one of non-empty ways to insert the fine grained line associated with the sector to be inserted 614 and whether there is free space in the FGST to insert the fine-grained line entry 616. If so, the method 600 may insert the sector in the fine-grained line 610 and the FGST keeps track of it. However, if there is not enough space to insert the fine grained line associated with the sector to be inserted 614 and/or if there is not enough free space in the FGST to insert the fine-grained line entry 616, a victim way may be selected 618 from the corresponding set. If the victim way includes one or more fine-grained lines 620, a fine-grained line in the way may be replaced with the fine-grained line associated with the incoming sector 622 and the incoming sector may be inserted in the newly inserted fine-grained line 610. The FGST may be updated to reflect the replacement. If the victim way does not include any fine-grained lines 620, the coarse-grained line in the way may be replaced with the coarse-grained line associated with the incoming way 624 and the incoming sector may be inserted in the newly inserted coarse-grained line 606. The tag array may be updated to reflect the replacement.

As discussed above, method 600 may select a victim way to insert a fine-grained line in certain circumstances. In an embodiment, a least recently used (LRU) policy within the set may be utilized to select the victim way. Utilizing an LRU policy may result in evenly spreading the fine-grained lines among the ways in a set. In an embodiment, a most recently used (MRU) policy within the set may be utilized to select the victim way. Utilizing the MRU policy may lower the impact of the replacement policy. In another embodiment, a way that is in between the MRU and LRU way may be selected as the victim way to attain the main advantages of MRU and LRU policies. For example, if the sectored cache has 16 ways, the 8th LRU way may be selected as the victim way. In a further embodiment, the way with fewest valid sectors may be selected as the victim way. This may evenly distribute the number of valid sectors per way.

Similarly, method 600 may select the position in a way to insert the fine-grained line when a fine-grained line replacement 622 is encountered. In an embodiment, fine-grained lines may be inserted starting at the last/first free sector within the way. This may utilize the free space within the way more efficiently and the FGST may include more bits to keep track of the position of the fine-grained lines. In another embodiment, fine-grained lines may be inserted into the same position as their sectors would occupy if the sectors were inserted into a coarse-grained line. This approach may require less bits for storing the position in the FGST.

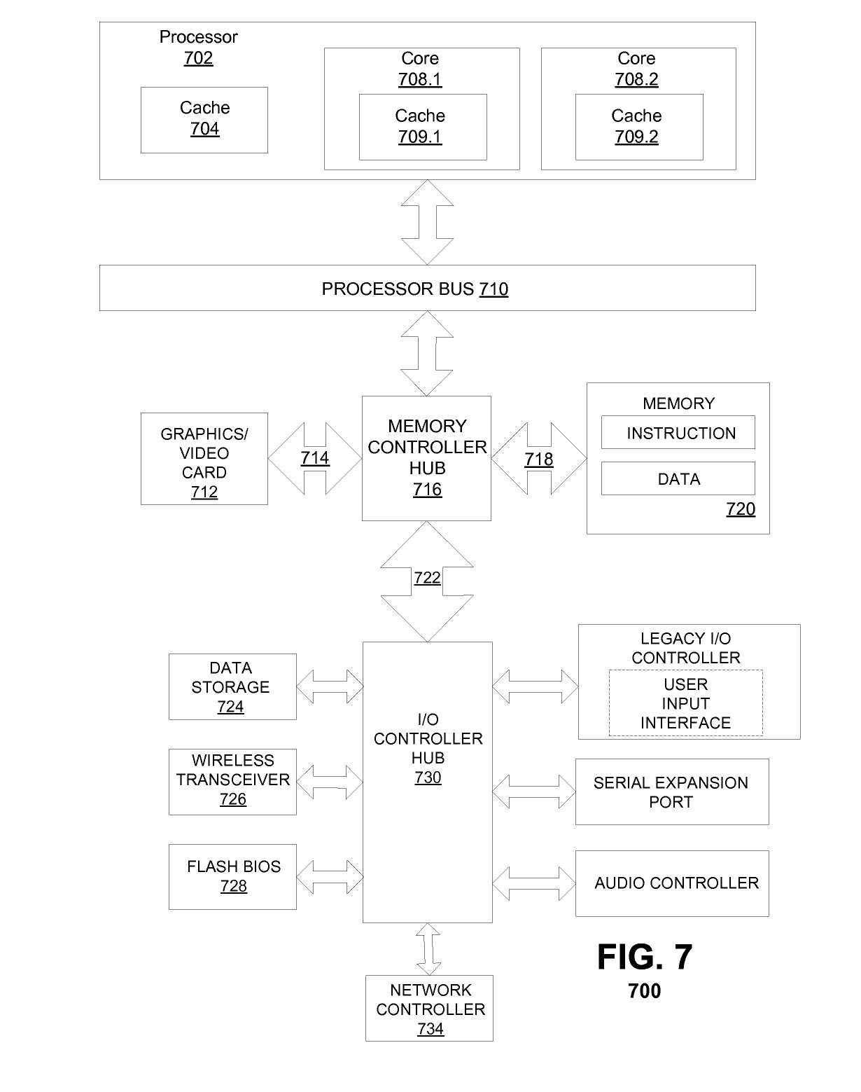

FIG. 7 is a block diagram of an exemplary computer system 700 formed with a processor 702 that includes one or more cores 708 (e.g., cores 708.1 and 708.2). Each core 708 may execute an instruction in accordance with one embodiment of the present invention. System 700 includes a component, such as a processor 702 to employ execution units including logic to perform algorithms for process data, in accordance with the present invention. System 700 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 700 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

One embodiment of the system 700 may be described in the context of a single processor desktop or server system, but alternative embodiments can be included in a multiprocessor system. System 700 may be an example of a ‘hub’ system architecture. The computer system 700 includes a processor 702 to process data signals. The processor 702 can be a complex instruction set computer (CISC) microprocessor, a reduced instruction set computing (RISC) microprocessor, a very long instruction word (VLIW) microprocessor, advanced vector extensions (AVX) microprocessor, streaming single instruction multiple data extensions (SSE) microprocessor, a processor implementing a combination of instruction sets, or any other processor device, such as a digital signal processor, for example. The processor 702 is coupled to a processor bus 710 that can transmit data signals between the processor 702 and other components in the system 700. The elements of system 700 perform their conventional functions that are well known to those familiar with the art.

Depending on the architecture, the processor 702 can have a single internal cache or multiple levels of internal cache. Alternatively, in another embodiment, the cache memory can reside external to the processor 702. Other embodiments can also include a combination of both internal and external caches depending on the particular implementation and needs. In one embodiment, the processor 702 may include a Level 2 (L2) internal cache memory 704 and each core (e.g., 708.1 and 708.2) may include a Level 1 (L1) cache (e.g., 709.1 and 709.2, respectively). In one embodiment, the processor 702 may be implemented in one or more semiconductor chips. When implemented in one chip, all or some of the processor 702's components may be integrated in one semiconductor die.

Each of the core 708.1 and 708.2 may also include respective register files (not shown) that can store different types of data in various registers including integer registers, floating point registers, status registers, and instruction pointer register. Each core 708 may further include logic to perform integer and floating point operations.

The processor 702 also includes a microcode (ucode) ROM that stores microcode for certain macroinstructions. For one embodiment, each core 708 may include logic to handle a packed instruction set (not shown). By including the packed instruction set in the instruction set of a general-purpose processor 702, along with associated circuitry to execute the instructions, the operations used by many multimedia applications may be performed using packed data in a general-purpose processor 702. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of the processor 702 can also be used in micro controllers, embedded processors, graphics devices, DSPs, and other types of logic circuits. System 700 includes a memory 720. Memory 720 can be a dynamic random access memory (DRAM) device, a static random access memory (SRAM) device, flash memory device, or other memory device. Memory 720 can store instructions and/or data represented by data signals that can be executed by the processor 702.

A system logic chip 716 is coupled to the processor bus 710 and memory 720. The system logic chip 716 in the illustrated embodiment is a memory controller hub (MCH). The processor 702 can communicate to the MCH 716 via a processor bus 710. The MCH 716 provides a high bandwidth memory path 718 to memory 720 for instruction and data storage and for storage of graphics commands, data and textures. The MCH 716 is to direct data signals between the processor 702, memory 720, and other components in the system 700 and to bridge the data signals between processor bus 710, memory 720, and system I/O 722. In some embodiments, the system logic chip 716 can provide a graphics port for coupling to a graphics controller 712. The MCH 716 is coupled to memory 720 through a memory interface 718. The graphics card 712 may be coupled to the MCH 716 through an Accelerated Graphics Port (AGP) interconnect 714.

System 700 uses a proprietary hub interface bus 722 to couple the MCH 716 to the I/O controller hub (ICH) 730. The ICH 730 provides direct connections to some I/O devices via a local I/O bus. The local I/O bus is a high-speed I/O bus for connecting peripherals to the memory 720, chipset, and processor 702. Some examples are the audio controller, firmware hub (flash BIOS) 728, wireless transceiver 726, data storage 724, legacy I/O controller containing user input and keyboard interfaces, a serial expansion port such as Universal Serial Bus (USB), and a network controller 734. The data storage device 724 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

A value, as used herein, includes any known representation of a number, a state, a logical state, or a binary logical state. Often, the use of logic levels, logic values, or logical values is also referred to as 1s and 0s, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

The embodiments of methods, hardware, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical storage device, optical storage devices, acoustical storage devices or other form of propagated signal (e.g., carrier waves, infrared signals, digital signals) storage device; etc. For example, a machine may access a storage device through receiving a propagated signal, such as a carrier wave, from a medium capable of holding the information to be transmitted on the propagated signal.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A method comprising:
associating a coarse-grained cache line with a way from a set in a cache;
storing a first sector of the coarse-grained cache line in the way, wherein the coarse-grained cache line includes a predetermined number of sectors;
associating a fine-grained cache line with the way; and
storing a second sector of the fine-grained cache line in the way, wherein the fine-grained cache line includes a predetermined number of sectors, wherein the predetermined number of sectors in the fine-grained cache line is lower than the predetermined number of sectors in the coarse-grained cache line.

2. The method of claim 1, wherein the predetermined number of sectors in the fine-grained line is one sector.

3. The method of claim 1, wherein the associating the coarse-grained cache line includes storing a line tag of the coarse-grained cache line in a tag array associated with the cache, and the storing the first sector includes setting an indicator in the tag array to indicate the first sector is valid.

4. The method of claim 1, wherein the associating the fine-grained cache line includes storing, in a data structure, an indicator indicating the way.

5. A method comprising:
if a sector to be inserted in a cache belongs to a coarse-grained cache line associated with a way in the cache, storing the sector in the way associated with the coarse-grained cache line; and
if the sector does not belong to any coarse-grained cache line associated with a way in the cache and if the sector belongs to a fine-grained cache line associated with a way in the cache, storing the sector in the way associated with the fine-grained cache line.

6. The method of claim 5, further comprising:
if the sector does not belong to any coarse-grained cache line associated with a way in the cache and if the sector does not belong to any fine-grained cache line associated with a way in the cache, searching for an empty way in a set corresponding to the sector; and
if the empty way is identified:
associating, with the empty way, a coarse-grained cache line including the sector, and
storing the sector in the empty way.

7. The method of claim 6, further comprising:
if no empty ways are available, searching for a way with free space to store a fine-grained cache line including the sector;
if the way with free space is identified, searching for free space to insert an entry in a data structure, wherein the data structure includes associations between fine-grained cache lines and ways in the cache; and
if the free space to insert the entry is available:
associating, in the data structure, the fine-grained cache line with the way with free space, and
storing the sector in the way with free space.

8. The method of claim 7, further comprising:
if ways with free space are not available or if free space to insert the entry is not available, identifying a victim way;
replacing one of a fine-grained line and a coarse-grained line in the victim way; and
storing the sector in the victim way.

9. The method of claim 8, wherein the victim way is identified through at least one of a least recently used policy and a most recently used policy.

10. An apparatus comprising:
a processor to execute computer instructions, wherein the processor is configured to:
associate a coarse-grained cache line with a way from a set in a cache;
store a first sector of the coarse-grained cache line in the way, wherein the coarse-grained cache line includes a predetermined number of sectors;
associate a fine-grained cache line with the way; and
store a second sector of the fine-grained cache line in the way, wherein the fine-grained cache line includes a predetermined number of sectors, wherein the predetermined number of sectors in the fine-grained cache line is lower than the predetermined number of sectors in the coarse-grained cache line.

11. The apparatus of claim 10, wherein the predetermined number of sectors in the fine-grained line is one sector.

12. The apparatus of claim 10, wherein to associate the coarse-grained cache line the processor is further configured to store a line tag of the coarse-grained cache line in a tag array associated with the cache, and to store the first sector the processor is further configured to set an indicator in the tag array to indicate the first sector is valid.

13. The apparatus of claim 10, wherein to associate the fine-grained cache line the processor is further configured to store, in a data structure, an indicator indicating the way.

14. An apparatus comprising:
a processor to execute computer instructions, wherein the processor is configured to:
if a sector to be inserted in a cache belongs to a coarse-grained cache line associated with a way in the cache, store the sector in the way associated with the coarse-grained cache line; and
if the sector does not belong to any coarse-grained cache line associated with a way in the cache and if the sector belongs to a fine-grained cache line associated with a way in the cache, store the sector in the way associated with the fine-grained cache line.

15. The apparatus of claim 14, wherein the processor is further configured to:
if the sector does not belong to any coarse-grained cache line associated with a way in the cache and if the sector does not belong to any fine-grained cache line associated with a way in the cache, search for an empty way in a set corresponding to the sector; and
if the empty way is identified:
associate, with the empty way, a coarse-grained cache line including the sector, and
store the sector in the empty way.

16. The apparatus of claim 15, wherein the processor is further configured to:
if no empty ways are available, search for a way with free space to store a fine-grained cache line including the sector;
if the way with free space is identified, search for free space to insert an entry in a data structure, wherein the data structure includes associations between fine-grained cache lines and ways in the cache; and
if the free space to insert the entry is available:
associate, in the data structure, the fine-grained cache line with the way with free space, and
store the sector in the way with free space.

17. The apparatus of claim 16, wherein the processor is further configured to:
if ways with free space are not available or if free space to insert the entry is not available, identify a victim way;
replace one of a fine-grained line and a coarse-grained line in the victim way; and
store the sector in the victim way.

18. The apparatus of claim 17, wherein the victim way is identified through at least one of a least recently used policy and a most recently used policy.

19. A non-transitory machine-readable medium having stored thereon an instruction, which if performed by a machine causes the machine to perform a method comprising:
associating a coarse-grained cache line with a way from a set in a cache;
storing a first sector of the coarse-grained cache line in the way, wherein the coarse-grained cache line includes a predetermined number of sectors;
associating a fine-grained cache line with the way; and
storing a second sector of the fine-grained cache line in the way, wherein the fine-grained cache line includes a predetermined number of sectors, wherein the predetermined number of sectors in the fine-grained cache line is lower than the predetermined number of sectors in the coarse-grained cache line.

20. A non-transitory machine-readable medium having stored thereon an instruction, which if performed by a machine causes the machine to perform a method comprising:
if a sector to be inserted in a cache belongs to a coarse-grained cache line associated with a way in the cache, storing the sector in the way associated with the coarse-grained cache line; and
if the sector does not belong to any coarse-grained cache line associated with a way in the cache and if the sector belongs to a fine-grained cache line associated with a way in the cache, storing the sector in the way associated with the fine-grained cache line.
